(19) United States
(12) Patent Application Publication
(10) Pub. No.: US 2025/0173505 A1
(43) Pub. Date: May 29, 2025

(54) INFORMATION PROCESSING SYSTEM, INFORMATION PROCESSING DEVICE, INFORMATION PROCESSING METHOD, AND RECORDING MEDIUM

(71) Applicant: Mitsubishi Electric Corporation, Tokyo (JP)

(72) Inventors: Hayato UCHIDE, Tokyo (JP); Koji TANAKA, Tokyo (JP); Kotaro OTOMURA, Tokyo (JP); Hiroaki SHIRAHAMA, Tokyo (JP)

(73) Assignee: Mitsubishi Electric Corporation, Tokyo (JP)

(21) Appl. No.: 19/042,160

(22) Filed: Jan. 31, 2025

Related U.S. Application Data
(63) Continuation of application No. PCT/JP2023/020376, filed on May 31, 2023.

(30) Foreign Application Priority Data
Mar. 16, 2023 (JP) 2023-041733

(51) Int. Cl. G06F 40/242; G06F 40/166

(52) U.S. Cl. CPC G06F 40/242; G06F 40/166

(57) ABSTRACT

An information processing system includes a pseudo keyword extraction unit that extracts a first pseudo keyword, which is a pseudo keyword, from learning text data for learning, a pseudo keyword assignment unit that assigns the first pseudo keyword to the learning text data, and a learning model generation unit that generates a learning model that has learned a correspondence relationship between context in the learning text data and the first pseudo keyword.

### CROSS REFERENCE TO RELATED APPLICATIONS

This application is a Continuation of PCT International Application No. PCT/JP2023/020376, filed on May 31, 2023, which claims priority under 35 U.S.C. 119 (a) to Patent Application No. 2023-041733, filed in Japan on Mar. 16, 2023, all of which are hereby expressly incorporated by reference into the present application.

### BACKGROUND OF THE INVENTION

### Field of the Invention

The present invention relates to an information processing system, an information processing device, an information processing method, and a program. The present application claims priority based on Japanese Patent Application No. 2023-041733 filed on Mar. 16, 2023, the contents of which are incorporated herein by reference.

### Description of Related Art

There is a technology of extracting keywords from a sentence. A dictionary is used to extract keywords.

For example, Japanese Unexamined Patent Application, First Publication No. 2013-171222 discloses that an unregistered word extraction unit extracts unregistered words that are not registered in a recognition dictionary, an unregistered word feature value extraction unit generates a co-occurrence frequency vector, a recognition result feature value extraction unit generates a word frequency vector, a task relevance calculation unit calculates task relevance and generates a provisional recognition result using a provisional recognition dictionary, a recognition reliability calculation unit calculates recognition reliability, a registration priority calculation unit calculates registration priority using reliability weights, and a recognition dictionary registration unit extracts additionally registered words and generates an extended dictionary using the additionally registered words and the like in the recognition dictionary.

### RELATED ART DOCUMENT

### Patent Document

Patent Document 1: Japanese Unexamined Patent Application, First Publication No. 2013-171222

### SUMMARY OF THE INVENTION

### Technical Problem

In order to improve the accuracy of extracting keywords such as technical terms, a technical term dictionary in which technical terms are registered is necessary.

However, the technology described in Japanese Unexamined Patent Application, First Publication No. 2013-171222 extracts keywords based on the dependencies of words appearing in a sentence and the frequency of appearance of words. Therefore, in a case where a technical term has a low frequency of appearance as a keyword, the keyword may not be extracted, and a keyword different from the actual technical term may be extracted. Furthermore, in keyword extraction using machine learning, in order to improve extraction accuracy, it is necessary to learn a large amount of data on the correspondence relationship between text data and correct keywords, and data selection and data collection require time and effort or cost.

Therefore, there is a problem in that the accuracy of keyword extraction cannot be improved. Thus, there is a problem in that user convenience in keyword extraction is not sufficient.

One aspect of the present invention has been made in consideration of the above points, and an objective of the present invention is to provide an information processing system, an information processing device, an information processing method, and a program that can improve user convenience in keyword extraction.

The present invention has been made to solve the above-mentioned problems, and according to one aspect of the present invention, there is provided an information processing system including: a learning text data acquisition unit to acquire learning text data for learning; a pseudo keyword extraction unit to extract a first pseudo keyword, which is a pseudo keyword, from the learning text data for learning; a pseudo keyword assignment unit to assign the first pseudo keyword to the learning text data; and a learning model generation unit to generate a learning model that has learned a correspondence relationship between context in the learning text data and the first pseudo keyword.

In addition, according to another aspect of the present invention, there is provided an information processing device including: a learning text data acquisition unit to acquire learning text data for learning; a pseudo keyword extraction unit to extract a first pseudo keyword, which is a pseudo keyword, from the learning text data for learning; a pseudo keyword assignment unit to assign the first pseudo keyword to the learning text data; and a learning model generation unit to generate a learning model that has learned a correspondence relationship between context in the learning text data and the first pseudo keyword.

In addition, according to still another aspect of the present invention, there is provided an information processing method executed by a computer, the information processing method including: learning text data acquisition process of acquiring learning text data for learning; a pseudo keyword extraction process of extracting a first pseudo keyword, which is a pseudo keyword, from the learning text data for learning; a pseudo keyword assignment process of assigning the first pseudo keyword to the learning text data; and a learning model generation process of generating a learning model that has learned a correspondence relationship between context in the learning text data and the first pseudo keyword.

In addition, according to yet still another aspect of the present invention, there is provided a program for causing a computer to execute: learning text data acquisition step of acquiring learning text data for learning; a pseudo keyword extraction step of extracting a first pseudo keyword, which is a pseudo keyword, from the learning text data for learning; a pseudo keyword assignment step of assigning the first pseudo keyword to the learning text data; and a learning model generation step of generating a learning model that has learned a correspondence relationship between context in the learning text data and the first pseudo keyword.

According to one aspect of the present invention, it is possible to improve user convenience in keyword extraction.

### BRIEF DESCRIPTION OF THE DRAWINGS

FIG. 1 is a system configuration diagram showing an example of a configuration of an information processing system according to a first embodiment of the present invention.

FIG. 2 is a block diagram showing an example of a hardware configuration of an information processing device according to the present embodiment.

FIG. 3 is a block diagram showing an example of a functional configuration of the information processing device according to the present embodiment.

FIG. 4 is a diagram showing an example of a display screen related to selection of technical terms according to the present embodiment.

FIG. 5 is a flowchart showing an example of information processing in the information processing system according to the present embodiment.

FIG. 6 is a block diagram showing an example of a functional configuration of an information processing device according to a second embodiment of the present invention.

FIG. 7 is a flowchart showing an example of information processing in an information processing system according to the present embodiment.

FIG. 8 is a block diagram showing an example of a functional configuration of an information processing device according to a third embodiment of the present invention.

FIG. 9 is a flowchart showing an example of information processing in an information processing system according to the present embodiment.

### DETAILED DESCRIPTION OF THE INVENTION

### First Embodiment

Embodiments of the present invention will be described below with reference to the drawings.

### Configuration of Information Processing System

First, a configuration of an information processing system will be described.

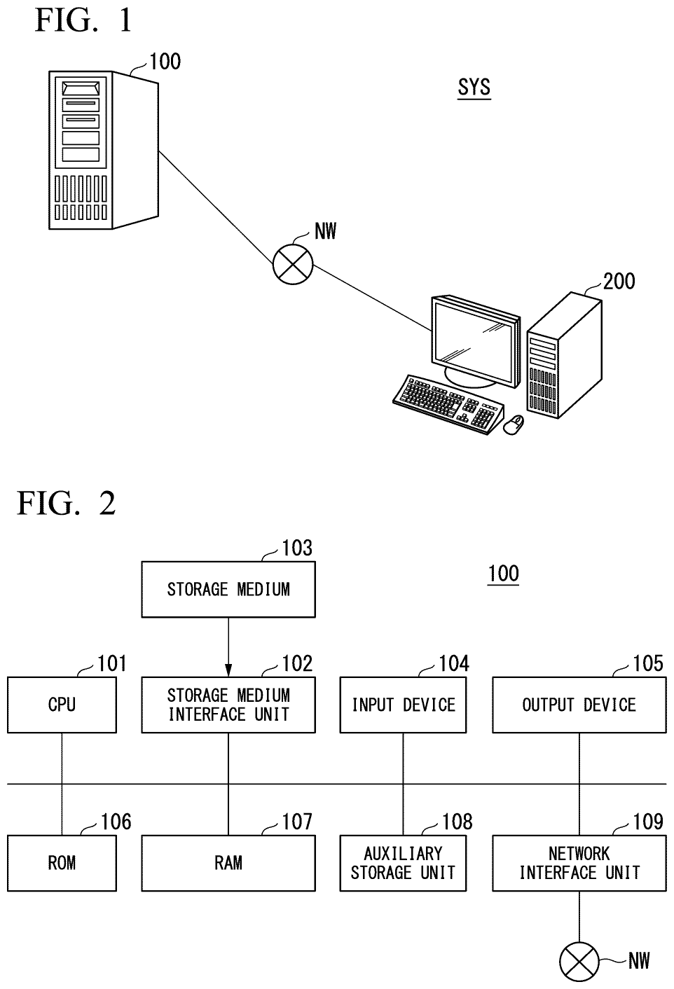

FIG. 1 is a system configuration diagram showing an example of a configuration of an information processing system according to a first embodiment of the present invention.

An information processing system SYS is a system that extracts keywords such as technical terms. Specifically, the information processing system SYS is a system that generates a dictionary for extracting keywords and extracts keywords using the generated dictionary.

More specifically, the information processing system SYS acquires learning text data for learning, and extracts a first pseudo keyword, which is a pseudo keyword, from the learning text data. The information processing system SYS assigns the first pseudo keyword to learning text data, and generates a learning model that has learned the correspondence relationship between the context in the learning text data and the first pseudo keyword. The information processing system SYS acquires text data and extracts keywords from the text data using the learning model.

With this configuration, the information processing system SYS can efficiently generate a dictionary used for extracting keywords. Therefore, the accuracy of keyword extraction can be improved. Furthermore, it is possible to improve user convenience in keyword extraction.

In the following description, a case will be described in which technical terms are extracted as keywords.

Next, a hardware configuration of an information processing device 100 will be described.

### Hardware Configuration

FIG. 2 is a block diagram showing an example of a hardware configuration of an information processing device 100 according to the present embodiment.

The information processing device 100 includes a CPU 101, a storage medium interface unit 102, a storage medium 103, an input device 104, an output device 105, a read only memory (ROM) 106, a random access memory (RAM) 107, an auxiliary storage unit 108, and a network interface unit 109. The CPU 101, the storage medium interface unit 102, the input device 104, the output device 105, the ROM 106, the RAM 107, the auxiliary storage unit 108, and the network interface unit 109 are mutually connected via a bus.

Note that the CPU 101 referred to here refers to a processor in general and includes not only a device called a CPU in the narrow sense, but also, for example, a GPU, a DSP, and the like. Furthermore, the CPU 101 referred to here is not limited to being realized by a single processor but may be realized by combining a plurality of processors of the same or different types.

### CPU 101

The CPU 101 controls the information processing device 100 by reading and executing programs stored in the auxiliary storage unit 108, the ROM 106, and the RAM 107, and by reading various types of data stored in the auxiliary storage unit 108, the ROM 106, and the RAM 107, and writing various types of data to the auxiliary storage unit 108 and the RAM 107. Furthermore, the CPU 101 reads various types of data stored in the storage medium 103 via the storage medium interface unit 102 and also writes various types of data to the storage medium 103.

### Storage Medium 103

The storage medium 103 is a portable storage medium such as a magneto-optical disk, a flexible disk, or a flash memory and stores various types of data.

### Storage Medium Interface Unit 102

The storage medium interface unit 102 is an interface for reading and writing data from and to the storage medium 103.

### Input Device 104

The input device 104 is an input device such as a mouse, a keyboard, a touch panel, a volume control button, a power button, a setting button, and an infrared receiving unit.

### Output Device 105

The output device 105 is an output device such as a display unit and a speaker.

### ROM 106 and RAM 107

The ROM 106 and the RAM 107 store programs for operating each functional unit of the information processing device 100 and various types of data.

### Auxiliary Storage Unit 108

The auxiliary storage unit 108 is a hard disk drive, a flash memory, or the like and stores programs for operating each functional unit of the information processing device 100 and various types of data.

### Network Interface Unit 109

The network interface unit 109 has a communication interface and is connected to a network NW via wireless communication.

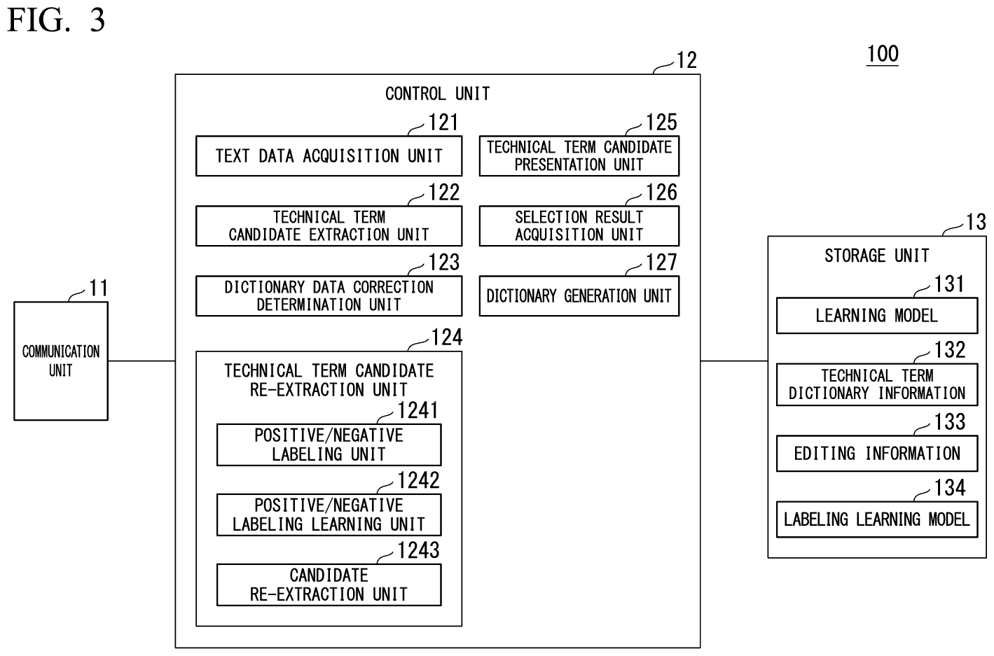

For example, the CPU 101 of the information processing device 100 corresponds to a control unit 12 in the functional configuration shown in FIG. 3, and the ROM 106, the RAM 107, the auxiliary storage unit 108, or any combination thereof corresponds to a storage unit 13 in the functional configuration shown in FIG. 3.

Although the hardware configuration of a user terminal device 200 is not shown or described, the user terminal device 200 has the same hardware configuration as the information processing device 100 shown in FIG. 2.

Next, a functional configuration of the information processing device 100 will be described.

### Functional Configuration of Information Processing Device 100

FIG. 3 is a block diagram showing an example of a functional configuration of the information processing device 100 according to the present embodiment.

The information processing device 100 includes a communication unit 11, a control unit 12, and a storage unit 13. The communication unit 11, the control unit 12, and the storage unit 13 are mutually connected via a bus.

### Communication Unit 11

The communication unit 11 has a function of communicating with the user terminal device 200. The communication unit 11 outputs various types of information received from the user terminal device 200 to the control unit 12. Moreover, the communication unit 11 transmits information input from the control unit 12 to the user terminal device 200.

### Control Unit 12

The control unit 12 has a function of controlling the information processing device 100. The control unit 12 reads various types of data, applications, programs, and the like stored in the storage unit 13 and controls the information processing device 100.

The process of the control unit 12 will be described in more detail.

The control unit 12 includes a text data acquisition unit 121, a technical term candidate extraction unit 122, a dictionary data correction determination unit 123, a technical term candidate re-extraction unit 124, a technical term candidate presentation unit 125, a selection result acquisition unit 126, and a dictionary generation unit 127.

### Text Data Acquisition Unit 121

The text data acquisition unit 121 acquires text data. Specifically, the text data acquisition unit 121 acquires text data stored in advance in the storage unit 13 or text data input by a user or the like.

### Technical Term Candidate Extraction Unit 122

The technical term candidate extraction unit 122 extracts character strings that are candidates for technical terms from the text data acquired by the text data acquisition unit 121. Specifically, the technical term candidate extraction unit 122 extracts candidates for technical terms from the text data using a learning model 131 stored in the storage unit 13. The learning model is a transformer model such as bidirectional encoder representations from transformers (BERT) that can determine in advance whether or not a term is a technical term based on context before and after the term.

### Dictionary Data Correction Determination Unit 123

The dictionary data correction determination unit 123 determines whether or not the technical term dictionary has been edited by the user. Specifically, the dictionary data correction determination unit 123 determines whether or not the technical term dictionary was edited by the user during the previous process. In a case where it is determined that the technical term dictionary was edited by the user during the previous process, the dictionary data correction determination unit 123 causes the technical term candidate re-extraction unit 124 to re-extract technical term candidates from the text data. In a case where it is determined that no edits were made to the technical term dictionary by the user during the previous process, a case where the process is a first process, or a case where the setting indicates reflecting edits made to the technical term dictionary by the user during the previous process, the dictionary data correction determination unit 123 causes the technical term candidate presentation unit 125 to present technical term candidates.

Here, it is assumed that the dictionary data correction determination unit 123 holds information as to whether or not the user's selection process of technical term candidates is the first time. It is assumed that the dictionary data correction determination unit 123 also holds setting information as to whether or not edits made to the technical term dictionary by the user during the previous process are to be reflected. Furthermore, it is assumed that the dictionary data correction determination unit 123 holds information as to whether or not the technical term dictionary was edited by the user during the previous process, and, in a case where editing was performed, the result of editing the technical term dictionary by the user. The result of editing the technical term dictionary by the user indicates the result of the user's selection as to whether or not each term is a technical term, as will be described later.

The dictionary data correction determination unit 123 may be configured to hold the number of times the selection process has been performed, instead of or in addition to holding information as to whether or not the user's selection process of technical term candidates is the first time.

### Technical Term Candidate Re-Extraction Unit 124

The technical term candidate re-extraction unit 124 re-extracts technical term candidates from the text data. Specifically, the technical term candidates are re-extracted based on the result of editing the technical term dictionary by the user during the previous process.

The technical term candidate re-extraction unit 124 will be described in more detail.

The technical term candidate re-extraction unit 124 includes a positive/negative labeling unit 1241, a positive/negative labeling learning unit 1242, and a candidate re-extraction unit 1243.

### Positive/Negative Labeling Unit 1241

The positive/negative labeling unit 1241 performs labeling based on the selection result indicating whether or not the term is a technical term selected by the user during the previous process. Specifically, the positive/negative labeling unit 1241 labels a technical term that has been selected to indicate that the term is a technical term as a positive example and labels a technical term that has not been selected to indicate that the term is a technical term as a negative example.

Here, the selection of technical term candidates by the user will be described.

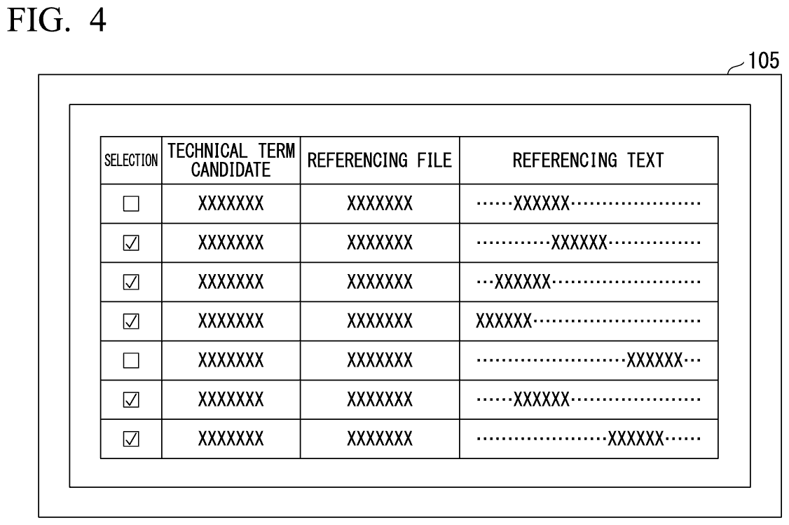

FIG. 4 is a diagram showing an example of a display screen related to selection of technical term candidates according to the present embodiment.

The example shown in the drawing is an example of a case where technical term candidates are displayed on the output device 105 of the information processing device 100, for example.

As shown in the drawing, the example display screen displays a plurality of technical term candidates, and for each technical term candidate, an operation component indicating whether or not to select a corresponding term, a referencing file, and a referencing text are displayed in association with each other.

The operation component indicating whether or not to select a corresponding term is, for example, a check box, and the operation component corresponding to the technical term candidate that the user selects as the technical term from among the plurality of technical term candidates is accepted for checking. The referencing file is information indicating a file of text data in which a technical term candidate appears. The referencing text is text such as sentences before and after the technical term candidate appears in the text data, or a phrase in which the technical term candidate appears in the text data.

The technical term candidates may be allowed to be added, deleted, or edited by the user at will. In the example shown in the drawing, there may be a plurality of referencing files, and there may be a plurality of referencing texts.

Referring back to FIG. 3, the positive/negative labeling unit 1241 labels the technical term candidates that are checked in response to the operation component indicating whether or not to select a corresponding term in FIG. 4 as positive examples and labels technical term candidates other than the checked technical term candidates, that is, technical term candidates that are not checked, as negative examples.

### Positive/Negative Labeling Learning Unit 1242

The positive/negative labeling learning unit 1242 generates a learning model (also referred to as a labeling learning model 134) that has learned the correspondence relationship between the positive/negative labeling by the positive/negative labeling unit 1241 and technical term candidates. For this learning, for example, Word2vec and conventional machine learning may be used, or a transformer model such as BERT may be used.

### Candidate Re-Extraction Unit 1243

The candidate re-extraction unit 1243 re-extracts technical term candidates from the text data using the labeling learning model 134 generated by the positive/negative labeling learning unit 1242.

### Technical Term Candidate Presentation Unit 125

The technical term candidate presentation unit 125 presents, to the user, one or both of the technical term candidates extracted by the technical term candidate extraction unit 122 and the technical term candidates extracted by the technical term candidate re-extraction unit 124. Specifically, the technical term candidate presentation unit 125 presents technical terms from the technical term candidates to the user so that the user can select the technical term, for example, as shown in the example display screen of FIG. 4.

### Selection Result Acquisition Unit 126

The selection result acquisition unit 126 acquires the user's selection results for the technical term candidates presented by the technical term candidate presentation unit 125. The selection result acquisition unit 126 stores the acquired selection result in the storage unit 13 as editing information.

### Dictionary Generation Unit 127

The dictionary generation unit 127 stores the technical terms selected by the user in the storage unit 13 as technical term dictionary information.

### Storage Unit 13

The storage unit 13 has a function of storing various types of data, applications, and programs.

The storage unit 13 also stores the learning model 131, technical term dictionary information 132, editing information 133, and a labeling learning model 134.

Next, a flow of information processing according to the present embodiment will be described.

### Flowchart

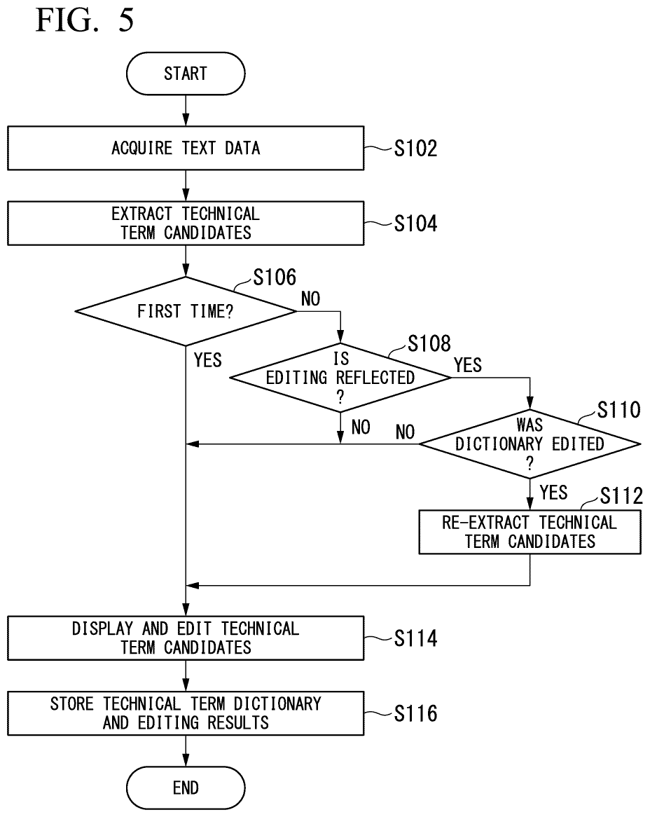

FIG. 5 is a flowchart showing an example of information processing in the information processing system SYS according to the present embodiment.

In step S102, the information processing device 100 acquires text data.

In step S104, the information processing device 100 uses the learning model 131 to extract technical term candidates from the text data.

In step S106, the information processing device 100 determines whether or not the process according to FIG. 5 is a first process. In a case where the process is the first process, the information processing device 100 performs the process of step S114. On the other hand, in a case where the process is not the first process, the information processing device 100 performs the process of step S108.

In step S108, the information processing device 100 determines whether or not the setting indicates reflecting the editing results. In a case where the setting indicates reflecting the editing results, the information processing device 100 performs the process of step S110. On the other hand, in a case where the setting indicates not reflecting the editing results, the information processing device 100 performs the process of step S114.

In step S110, the information processing device 100 determines whether or not the dictionary was edited by the user during the previous process. In a case where it is determined that the dictionary was edited by the user during the previous process, the information processing device 100 performs the process of step S112. On the other hand, in a case where it is determined that the dictionary was not edited by the user during the previous process, the information processing device 100 performs the process of step S114.

In step S112, the information processing device 100 re-extracts technical term candidates from the text data.

In step S114, the information processing device 100 presents technical term candidates to the user and accepts the selection of a technical term.

In step S116, the information processing device 100 stores the selected technical terms in the storage unit 13 as technical term dictionary information. Furthermore, the information processing device 100 stores the acquired selection result in the storage unit 13 as editing information.

### Second Embodiment

Next, a second embodiment of the present invention will be described.

In the second embodiment, the generation of a learning model 131 for extracting technical term candidates will be described.

In addition, in the second embodiment, the differences from the first embodiment will be mainly described.

### Information Processing Device 100

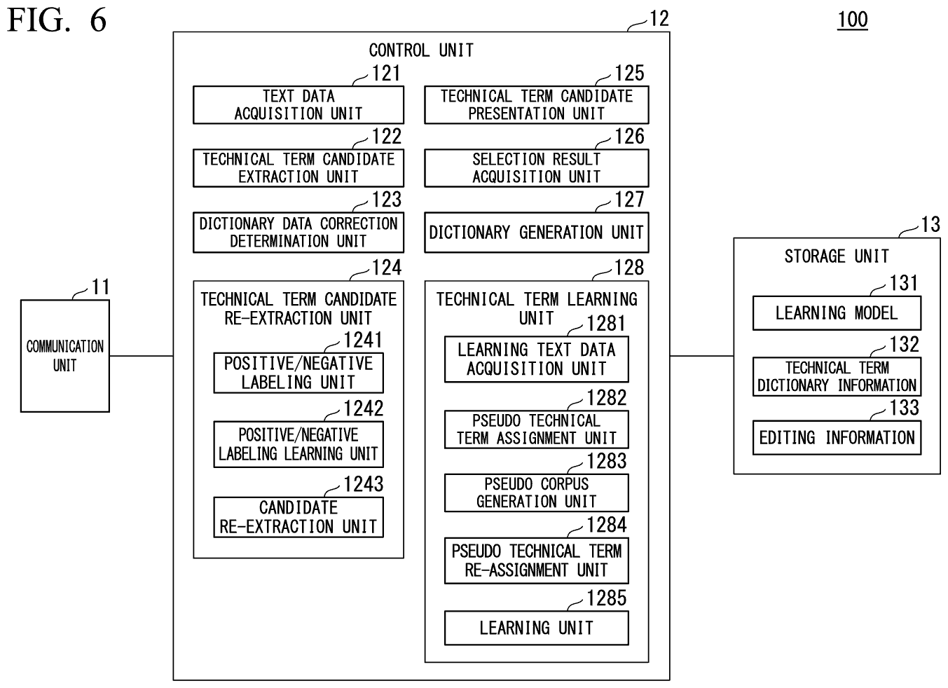

FIG. 6 is a block diagram showing an example of a functional configuration of an information processing device 100 according to the second embodiment of the present invention.

The information processing device 100 includes a communication unit 11, a control unit 12, and a storage unit 13. The communication unit 11, the control unit 12, and the storage unit 13 are mutually connected via a bus.

The control unit 12 includes a text data acquisition unit 121, a technical term candidate extraction unit 122, a dictionary data correction determination unit 123, a technical term candidate re-extraction unit 124, a technical term candidate presentation unit 125, a selection result acquisition unit 126, a dictionary generation unit 127, and a technical term learning unit 128. The technical term candidate re-extraction unit 124 includes a positive/negative labeling unit 1241, a positive/negative labeling learning unit 1242, and a candidate re-extraction unit 1243. The technical term learning unit 128 includes a learning text data acquisition unit 1281, a pseudo technical term assignment unit 1282, a pseudo corpus generation unit 1283, a pseudo technical term re-assignment unit 1284, and a learning unit 1285.

### Learning Text Data Acquisition Unit 1281

The learning text data acquisition unit 1281 acquires text data for learning. Specifically, the learning text data acquisition unit 1281 acquires text data for learning stored in the storage unit 13 or text data for learning input by the user.

### Pseudo Technical Term Assignment Unit 1282

The pseudo technical term assignment unit 1282 performs a technical term extraction process on the learning text data for learning acquired by the learning text data acquisition unit 1281 and extracts technical terms from the learning text data. The technical term extraction process may use, for example, scoring using Position Rank. The pseudo technical term assignment unit 1282 assigns information that specifies the extracted technical term as a first pseudo training technical term (also called a first pseudo keyword) to the learning text data.

In addition, the information for specifying the first pseudo training technical term may be, for example, BIO-format tagging used for a “sequence leveling problem” such as named entity extraction.

In this case, for example, when the sentence “decision on introduction of long-term interest rate manipulation”, is divided into morphemes, “long-term”, “interest rate”, “manipulation”, “of”, “introduction”, “on”, and “decision” are divided. Among these, in a case where “long-term interest rate manipulation” is the first pseudo training technical term, tags only need to be assigned as follows: tag “B” for “long-term”, tag “I” for “interest rate”, tag “I” for “manipulation”, tag “O” for “of”, tag “O” for “introduction”, tag “O” for “on”, and tag “O” for “decision”.

Here, the tag “B” represents the beginning, that is, the first word of a technical term, the tag “I” represents the inside, that is, a word other than the first word of a technical term, and the tag “O” represents the outside, that is, a word other than a technical term.

### Pseudo Corpus Generation Unit 1283

The pseudo corpus generation unit 1283 generates a pseudo corpus by replacing the technical term in each sentence in the text data for learning to which the first pseudo training technical term has been assigned with a second pseudo training technical term generated in accordance with a predetermined rule. The pseudo corpus generation unit 1283 assigns the second pseudo training technical term and the pseudo corpus to the text data for learning to which the first pseudo training technical term has been assigned.

For example, when “◯◯” in expressions such as “as ◯◯” or “according to ◯◯” is a technical term, the pseudo corpus generation unit 1283 replaces “◯◯” with a predetermined rule, for example a random word, such as “ΔΔ” and generates pseudo sentences such as “as ΔΔ” and “according to ΔΔ”.

For example, “ΔΔ” is a different technical term in the same field as “◯◯” Alternatively, “ΔΔ” may be a technical term in a field different from “◯◯” Alternatively, “ΔΔ” may not be a technical term, but may be any word or compound word mechanically selected at random, or any word or compound word selected by the user. The predetermined rule may restrict the part of speech of the word to be replaced.

In this way, it is possible to learn the contexts in which technical terms are likely to appear in sentences in the target text data, rather than the words themselves that are likely to become technical terms in sentences in the target text data. Therefore, the accuracy of technical term extraction can be improved.

Although the information processing device 100 can improve the accuracy of technical term extraction without having the configuration of the pseudo corpus generation unit 1283, by using the pseudo corpus generation unit 1283, it is possible to learn context, thereby further improving the accuracy of technical term extraction.

### Pseudo Technical Term Re-Assignment Unit 1284

The pseudo technical term re-assignment unit 1284 determines whether or not the technical term dictionary has been edited by the user during the previous process. The pseudo technical term re-assignment unit 1284 re-assigns the first pseudo training technical term using the results of the previous editing, except a case where the current process is the first process or a case where the setting indicates not reflecting the editing results of the technical term dictionary.

Specifically, the pseudo technical term re-assignment unit 1284 performs labeling based on the selection result indicating whether or not the term is a technical term selected by the user during the previous process. Specifically, the pseudo technical term re-assignment unit 1284 labels a technical term that has been selected to indicate that the term is a technical term as a positive example, and labels a technical term that has not been selected to indicate that the term is a technical term as a negative example.

The pseudo technical term re-assignment unit 1284 generates a learning model that has learned the correspondence relationship between positive/negative labeling and technical term candidates. For this learning, for example, Word2vec and conventional machine learning may be used, or a transformer model such as BERT may be used.

The pseudo technical term re-assignment unit 1284 uses the generated learning model to re-extract technical term candidates from the text data for learning and re-assigns the re-extracted technical term candidates to the text data for learning as first pseudo training technical terms.

### Learning Unit 1285

The learning unit 1285 generates a learning model 131 that extracts pseudo training technical terms. Specifically, the learning unit 1285 learns the context in which technical terms appear by learning the correspondence relationship between the pseudo training technical terms and the context in which the pseudo training technical terms appear using a BERT or the like that is capable of learning context. The learning unit 1285 stores the generated learning model in the storage unit 13.

In this way, the learning unit 1285 generates a learning model that can take into account the surrounding context of the word in the sentence, thereby learning not only the frequency and dependency relationships of words but also the contexts in which technical terms are likely to appear, and is able to extract unknown technical terms with high accuracy.

Next, a flow of information processing according to the present embodiment will be described.

### Flowchart

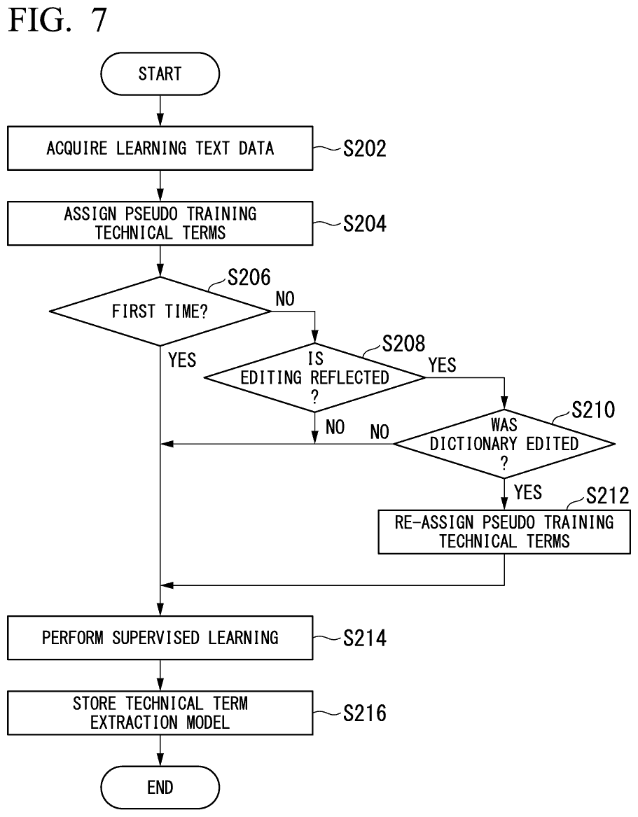

FIG. 7 is a flowchart showing an example of information processing in the information processing system SYS according to the present embodiment.

In step S202, the information processing device 100 acquires text data for learning.

In step S204, the information processing device 100 extracts technical term candidates from the text data for learning and assigns the extracted technical term candidates to the text data for learning as first pseudo training technical terms.

In step S206, the information processing device 100 determines whether or not the process according to FIG. 7 is a first process. In a case where the process is the first process, the information processing device 100 performs the process of step S214. On the other hand, in a case where the process is not the first process, the information processing device 100 performs the process of step S208.

In step S208, the information processing device 100 determines whether or not the setting indicates reflecting the editing results. In a case where the setting indicates reflecting the editing results, the information processing device 100 performs the process of step S210. On the other hand, in a case where the setting indicates not reflecting the editing results, the information processing device 100 performs the process of step S214.

In step S210, the information processing device 100 determines whether or not the dictionary was edited by the user during the previous process. In a case where it is determined that the dictionary was edited by the user during the previous process, the information processing device 100 performs the process of step S212. On the other hand, in a case where it is determined that the dictionary was not edited by the user during the previous process, the information processing device 100 performs the process of step S214.

In step S212, the information processing device 100 re-extracts technical term candidates from the text data for learning and re-assigns the re-extracted technical term candidates to the text data for learning as first pseudo training technical terms.

In step S214, the information processing device 100 generates a technical term extraction model that has learned the correspondence relationship between the pseudo training technical terms and the contexts in which the pseudo training technical terms appear.

In step S216, the information processing device 100 stores the generated technical term extraction model in the storage unit 13 as a learning model.

Thus, the information processing system SYS according to the first and second embodiments includes a learning text data acquisition unit 1281 that acquires learning text data for learning, a pseudo keyword extraction unit (pseudo technical term assignment unit 1282) that extracts a first pseudo keyword, which is a pseudo keyword, from the learning text data, a pseudo keyword assignment unit (pseudo technical term assignment unit 1282) that assigns information for specifying the first pseudo keyword to the learning text data, and a learning model generation unit (learning unit 1285) that generates a learning model that has learned the correspondence relationship between the context in the learning text data and the first pseudo keyword.

Specifically, the learning model is generated by learning the correspondence relationship between the context in the learning text data and the first pseudo keyword. For example, when text data is input as input information to the generated learning model, keywords are obtained as output information. A keyword extraction unit (technical term candidate extraction unit 122) uses a learning model to extract keywords from predetermined text data.

Accordingly, the cost of creating training technical terms can be reduced by using the results of technical term extraction through unsupervised learning as pseudo training technical term. In addition, it is possible to generate a learning model that has learned the surrounding context of the word in the sentence in the text data, thereby making it possible to extract unknown technical terms with high accuracy. In addition, by manually checking and correcting only the extracted technical terms, a high-quality dictionary can be generated at low cost. In addition, by generating a labeling learning model 134 based on the edit contents made to the technical term dictionary by the user, technical terms that match the user's purpose, application, and preferences can be re-extracted, thereby further improving the accuracy of dictionary generation.

### Third Embodiment

Next, a third embodiment of the present invention will be described.

In the third embodiment, an example of a case where technical terms are extracted using a technical term dictionary generated based on one or both of the first and second embodiments will be described.

### User Terminal Device 200

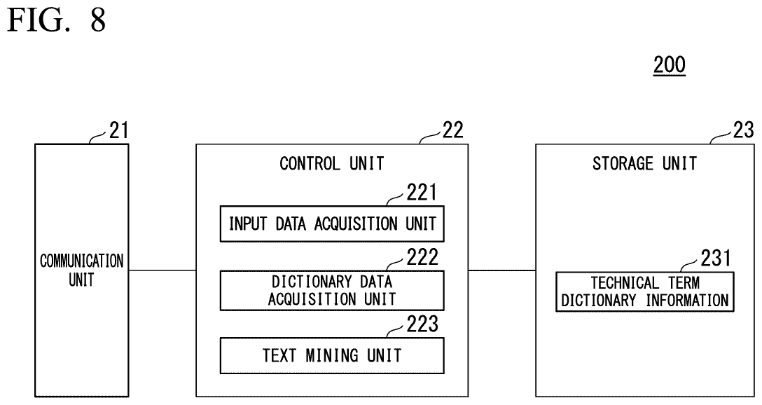

FIG. 8 is a block diagram showing an example of a configuration of a user terminal device 200 according to a third embodiment of the present invention.

The user terminal device 200 includes a communication unit 21, a control unit 22, and a storage unit 23.

### Communication Unit 21

The communication unit 21 has a function of communicating with the information processing device 100. The communication unit 21 outputs various types of information received from the information processing device 100 to the control unit 22. Moreover, the communication unit 21 transmits information input from the control unit 22 to the information processing device 100.

### Control Unit 22

The control unit 22 has a function of controlling the user terminal device 200. The control unit 22 reads various types of data, applications, programs, and the like stored in the storage unit 23 and controls the information processing device 100.

The process of the control unit 22 will be described in more detail.

The control unit 22 includes an input data acquisition unit 221, a dictionary data acquisition unit 222, and a text mining unit 223.

### Input Data Acquisition Unit 221

The input data acquisition unit 221 acquires input data from a user. The input data is voice data or text data. In a case where the input data is voice data, the input data acquisition unit 221 converts the voice data into text data by voice recognition. The input data acquisition unit 221 outputs the text data to the text mining unit 223.

### Dictionary Data Acquisition Unit 222

The dictionary data acquisition unit 222 acquires technical term dictionary information from the information processing device 100 via the communication unit 21. The dictionary data acquisition unit 222 stores the acquired technical term dictionary information in the storage unit 23.

### Text Mining Unit 223

The text mining unit 223 performs text mining on the text data and extracts technical terms from the text data by referring to the technical term dictionary information stored in the storage unit 23.

### Flowchart

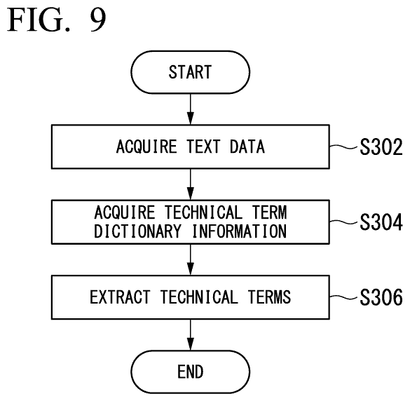

FIG. 9 is a flowchart showing an example of a flow of information processing according to the present embodiment.

In step S302, the user terminal device 200 acquires text data or voice data from the user as input data. When the data is voice data, the user terminal device 200 converts the voice data into text data.

In step S304, the user terminal device 200 acquires technical term dictionary information from the information processing device 100.

In step S306, the user terminal device 200 refers to the technical term dictionary information and extracts technical terms from the text data.

In the first embodiment, it has been described that the user can add, delete, and edit technical term candidates at will; however, according to the present embodiment, technical terms can be extracted in the user terminal device 200. This allows users to add technical terms based on their wishes.

Each embodiment of the present invention has been described in detail above with reference to the drawings, but the specific configurations are not limited to those described above, and various design changes, and the like are possible within the scope that does not deviate from the gist of the present invention.

For example, in each of the above-described embodiments, an example has been described in which the information processing device 100 and the user terminal device 200 are configured as individual devices, but one aspect of the present invention may also be realized by a device that combines some or all of these devices, or a device in which some of these devices are rearranged.

In addition, the program that operates on the information processing device 100 and the user terminal device 200 in one aspect of the present invention may be a program that controls one or more processors such as a central processing unit (CPU) (a program that causes a computer to function) to realize the functions shown in each of the above embodiments and modification examples related to one aspect of the present invention. The computer referred to here also includes a quantum computer. The information handled by each of these devices is temporarily stored in a random access memory (RAM) during processing, and is then stored in various storages such as a flash memory or a hard disk drive (HDD), and may be read, modified, or written by a CPU or the like as necessary.

Note that the information processing device 100 and the user terminal device 200 in each of the above-described embodiments and modification examples may be partly or entirely realized by a computer having one or more processors. In such a case, a program for realizing the control functions may be recorded in a computer-readable recording medium, and the functions may be realized by reading the program recorded on this recording medium into a computer system, and executing the program.

The “computer system” referred to here is a computer system built into the information processing device 100 and the user terminal device 200, and includes hardware such as an OS and peripheral devices. In addition, the term “computer-readable recording medium” refers to a storage device such as a portable medium such as a flexible disk, a magneto-optical disk, a ROM, or a CD-ROM, a hard disk that is built into the computer system, or the like.

Further, the term “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program may be provided to realize a part of the above-described functions, or may be provided to be capable of realizing the above-described functions in combination with a program already recorded on the computer system.

Furthermore, the information processing device 100 and the user terminal device 200 in each of the above-described embodiments and modification examples may be partly or entirely realized as an LSI, which is typically an integrated circuit, or as a chipset. Furthermore, each functional block of the information processing device 100 and the user terminal device 200 in each of the above-described embodiments and modification examples may be individually formed into a chip, or part or all of them may be integrated into a chip. Furthermore, the integrated circuit technique is not limited to LSI, and may be realized by a dedicated circuit and/or a general-purpose processor. Furthermore, in a case where an integrated circuit technology that can replace LSIs appears due to advances in semiconductor technology, it may be possible to use an integrated circuit based on that technology.

While embodiments or modification examples as an aspect of the present invention have been described in detail with reference to the drawings, specific configurations are not limited to the embodiments or modification examples and design change or the like in a range not departing from the abstract of the present invention is also included. In addition, an aspect of the present invention can be changed in a range shown in the claims, and embodiments obtained by combining technical means disclosed in different embodiments are also included in the technical scope of the present invention. Moreover, configurations that are described in the above embodiments or modification examples and are obtained by replacing factors showing similar effects with each other are also included.

### INDUSTRIAL APPLICABILITY

One aspect of the present invention can be used in, for example, an information processing system, an information processing device, an information processing method, and a program. REFERENCE SIGNS LIST
SYS: Information processing system
100: Information processing device
11: Communication unit
12: Control unit
121: Text data acquisition unit
122: Technical term candidate extraction unit
123: Dictionary data correction determination unit
124: Technical term candidate re-extraction unit
1241: Positive/negative labeling unit
1242: Positive/negative labeling learning unit
1243: Candidate re-extraction unit
125: Technical term candidate presentation unit
126: Selection result acquisition unit
127: Dictionary generation unit
128: Technical term learning unit
1281: Learning text data acquisition unit
1282: Pseudo technical term assignment unit
1283: Pseudo corpus generation unit
1284: Pseudo technical term re-assignment unit
1285: Learning unit
13: Storage unit
131: Learning model
132: Technical term dictionary information
133: Editing information
200: User terminal device
21: Communication unit
22: Control unit
221: Input data acquisition unit
222: Dictionary data acquisition unit
223: Text mining unit
23: Storage unit
231: Technical term dictionary information

1. An information processing system comprising:
a processor to execute a program; and
a memory to store the program which, when executed by the processor, performs processes of:
extracting a first pseudo keyword, which is a pseudo keyword, from learning text data for learning;
assigning information for specifying the first pseudo keyword to the learning text data; and
generating a learning model that has learned a correspondence relationship between context in the learning text data and the first pseudo keyword.

2. The information processing system according to claim 1, wherein the program further performs a process of extracting a keyword from text data using the learning model.

3. The information processing system according to claim 1,
wherein the program further performs processes of:
generating a pseudo sentence by replacing the first pseudo keyword appearing in the learning text data with a second pseudo keyword generated in accordance with a predetermined rule; and
learning a correspondence relationship between the second pseudo keyword and the pseudo sentence.

4. The information processing system according to claim 2,
wherein the program further performs processes of:
presenting the keyword to a user in an editable manner; and
generating a learning model that has further learned a correspondence relationship between the keyword edited by the user and context of a sentence in which the edited keyword appears.

5. An information processing device comprising:
a processor to execute a program; and
a memory to store the program which, when executed by the processor, performs processes of:
extracting a first pseudo keyword, which is a pseudo keyword, from learning text data for learning;
assigning the first pseudo keyword to the learning text data; and
generating a learning model that has learned a correspondence relationship between context in the learning text data and the first pseudo keyword.

6. An information processing method comprising:
extracting a first pseudo keyword, which is a pseudo keyword, from learning text data for learning;
assigning the first pseudo keyword to the learning text data; and
generating a learning model that has learned a correspondence relationship between context in the learning text data and the first pseudo keyword.

7. A computer readable non-transitory recording medium having a program for causing a computer to execute:
extracting a first pseudo keyword, which is a pseudo keyword, from learning text data for learning;
assigning the first pseudo keyword to the learning text data; and
generating a learning model that has learned a correspondence relationship between context in the learning text data and the first pseudo keyword.
